(19) United States
(12) Patent Application Publication
(10) Pub. No.: US 2004/0243783 A1
(43) Pub. Date: Dec. 2, 2004

(54) Method and apparatus for multi-mode operation in a semiconductor circuit

(76) Inventors: Zhimin Ding, Sunnyvale, CA (US); Shane C. Hollmer, San Jose, CA (US); Philip C. Barnett, Clanfield (GB)

Correspondence Address: ATMI, INC., 7 COMMERCE DRIVE, DANBURY, CT, 06810, US

(21) Appl. No.: 10/448,944

(22) Filed: May 30, 2003

(51) Int. Cl. G06F 12/00

(52) U.S. Cl. 711/170; 711/154

(57) ABSTRACT

A multi-mode architecture is disclosed for a semiconductor circuit, such as a smart card, microcontroller or another single-chip data processing circuit. The disclosed semiconductor circuit supports at least two modes of operation. A memory management unit restricts each application to a predetermined memory range and enforces certain mode-specific restrictions for each memory partition. In a secure kernel mode, all resources and services on the semiconductor circuit, such as special function registers, are accessible. In an application mode, certain special function registers are not accessible (and thus, the resources associated with such special function registers are also not accessible). The operating system is normally executed in a secure kernel mode, where most, if not all resources are accessible. Likewise, a user application is normally executed in a user mode, where certain resources are not accessible. If an application attempts to access a restricted resource in a user mode, a fault interrupt is generated. If a user application needs to access a restricted resource that is only available in the kernel mode, the user application invokes the kernel mode using an interrupt.

### FIELD OF THE INVENTION

The present invention relates generally to methods and apparatus for partitioning memory in a semiconductor circuit, such as a secure integrated circuit, and more particularly, to a method and apparatus for multi-mode operation in a semiconductor circuit.

### BACKGROUND OF THE INVENTION

Multiple applications must frequently coexist on the same semiconductor circuit. For example, smart cards frequently contain more than one application. On many semiconductor circuit platforms, however, such as the Intel 80C51™, the various applications are typically not protected from one another. If proper precautions are not taken, the security of the semiconductor circuit or one or more applications executing on the semiconductor circuit may be compromised. For example, a rogue application may improperly access stored code or data of another application or manipulate the hardware on the semiconductor circuit to indirectly influence the operation of the semiconductor circuit.

Generally, when multiple applications coexist on a semiconductor circuit, an application should not be able to access memory that is outside of a predetermined memory range that is assigned to the application. U.S. Pat. No. 6,292,874 to Phillip C. Barnett, entitled “Memory Management Method and Apparatus for Partitioning Homogeneous Memory and Restricting Access of Installed Applications to Predetermined Memory Ranges,” discloses a memory management unit for a semiconductor circuit that restricts access of installed applications executing in the microprocessor core to predetermined memory ranges. The disclosed memory management unit limits applications to allocated program code and data areas. Thus, each application is isolated from all other applications.

Moreover, a semiconductor circuit also includes an operating system, which provides services to the various applications executing on the semiconductor circuit. Typically, the operating system has exclusive access to certain hardware on the semiconductor circuit, such as non-volatile memories and cryptographic coprocessors. In order for a semiconductor circuit to be secure, an application should not be able to freely access data and resources that are meant for exclusive access by the operating system. The operating system may allow applications to use certain services provided by the operating system, subject to the security policies defined by the operating system. Ideally, the security policies should be enforced by hardware on the semiconductor circuit.

Allowing the various applications and operating system on a semiconductor circuit to access various services and resources on the semiconductor circuit is particularly challenging in a multiple application environment, where different processes may have different levels of privilege. Thus, a need exists for a method and apparatus for allowing multi-mode operation on a semiconductor circuit. A further need exists for a method and apparatus for restricting the ability of multiple applications to access resources and services based on the current operating mode of the semiconductor circuit.

### SUMMARY OF THE INVENTION

Generally, a multi-mode architecture is disclosed for a semiconductor circuit, such as a smart card, microcontroller or another single-chip data processing circuit. According to one aspect of the present invention, the semiconductor circuit supports at least two modes of operation. The semiconductor circuit employs a memory management unit to restrict each application to a predetermined memory range and to enforce certain mode-specific restrictions for each memory partition. In a secure kernel mode, all resources and services on the semiconductor circuit, such as special function registers, are accessible. In an application mode, certain special function registers are not accessible (and thus, the resources associated with such special function registers are also not accessible).

Normally, the operating system is executed in a secure kernel mode, where most, if not all resources are accessible. Likewise, a user application is normally executed in a user mode, where certain resources are not accessible. If an application attempts to access a restricted resource in a user mode, a fault interrupt is generated. If a user application needs to access a restricted resource that is only available in the kernel mode, the user application invokes the kernel mode using an interrupt.

The memory management unit of the present invention extends a conventional memory management unit to support multiple modes of operation. The semiconductor circuit has a different memory map for each mode. Special function registers are employed for each memory partition to record the physical and logical addresses, partition size and memory characteristics/restrictions (memory type, partition type and access type). In addition, the present invention extends the conventional functions of a processor core to support multi-mode operation. The processor core includes logic and special function registers for performing the mode switching of the present invention. The special function registers record a mode bit that specifies the current mode of the processor core, and to save the mode bit upon an interrupt for each interrupt state (low and high priority).

Mode switching is performed in accordance with the present invention through an invoked interrupt and then returning from the interrupt. A software interrupt is thus added to the architecture to allow voluntary mode switching. The software interrupt is invoked by writing to an interrupt bit. When the interrupt is serviced, the program branches to an address pointed to by an interrupt vector and at the same time, the operating mode is switched to the secure kernel mode. The execution address of the next instruction in sequence before entering the interrupt is also saved to the stack, and the operating mode before the interrupt is saved in a saved mode, SM, bit of a special function register that is appropriate for the current interrupt state (low and high priority). On returning from the software interrupt, the program execution will branch to where the execution was interrupted and continue from there. The operating mode will be restored to what was saved in the saved mode, SM, register.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a semiconductor circuit incorporating features of the present invention;

FIG. 2 illustrates the relationship between a physical address and logical address in the memory of FIG. 1;

FIG. 3 is a schematic block diagram of the processor core of FIG. 1;

FIG. 4 is a schematic block diagram of the memory management unit of FIG. 1;

FIG. 5 is an exemplary special function register used by the processor of FIGS. 1 and 3 for storing a mode bit that controls the mode switching of the present invention;

FIG. 6 is an exemplary special function register used by the processor of FIGS. 1 and 3 for storing a saved mode bit for each interrupt state;

FIG. 7 is a flow chart illustrating the mode switching in accordance with the present invention;

FIGS. 8A and 8B, respectively, are logic specifications for performing mode switching during execution of an interrupt and a return from an interrupt;

FIG. 9 is an exemplary special function register used by the memory management unit of FIGS. 1 and 4 for storing memory partitioning information;

FIG. 10 is a schematic block diagram of the address partitioning, protection and mapping logic used by the memory management unit of FIG. 4; and

FIG. 11 is a schematic block diagram of a mechanism for restricting access to peripheral devices in accordance with one embodiment of the present invention.

### DETAILED DESCRIPTION OF PREFERRED EMBODIMENTS

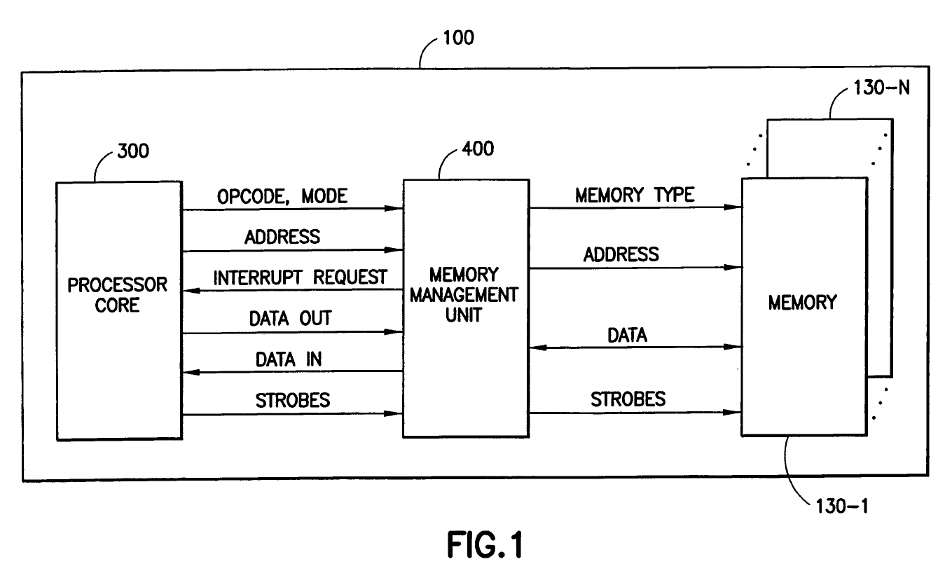

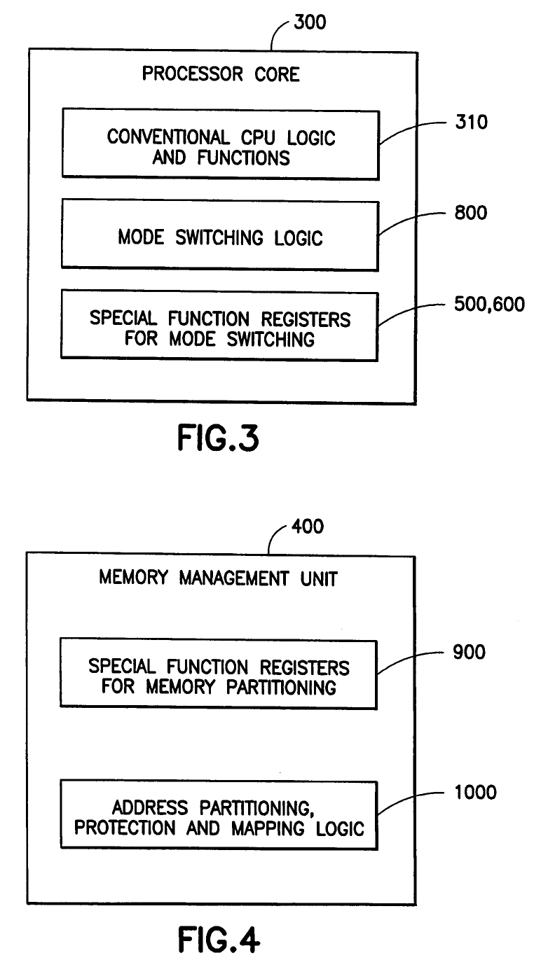

FIG. 1 is a schematic block diagram of a semiconductor circuit 100 incorporating features of the present invention. The semiconductor circuit 100 may be embodied as a smart card or another single-chip data processing circuit. As shown in FIG. 1, the semiconductor circuit 100 includes a processor core 300, discussed further below in conjunction with FIG. 3, a memory management unit 400, discussed further below in conjunction with FIG. 4, and one or more memory devices 130-1 through 130-N. Generally, the memory management unit 400 interfaces between the processor core 300 and the memory devices 130 for memory access operations. The memory management unit 400 imposes firewalls between applications and permits hardware checked partitioning of the memory. Thus, each application has limited access to only a predetermined memory range. The various signals shown in FIG. 1 that are exchanged between the processor core 300, memory management unit 400 and memory 130 will be discussed further below.

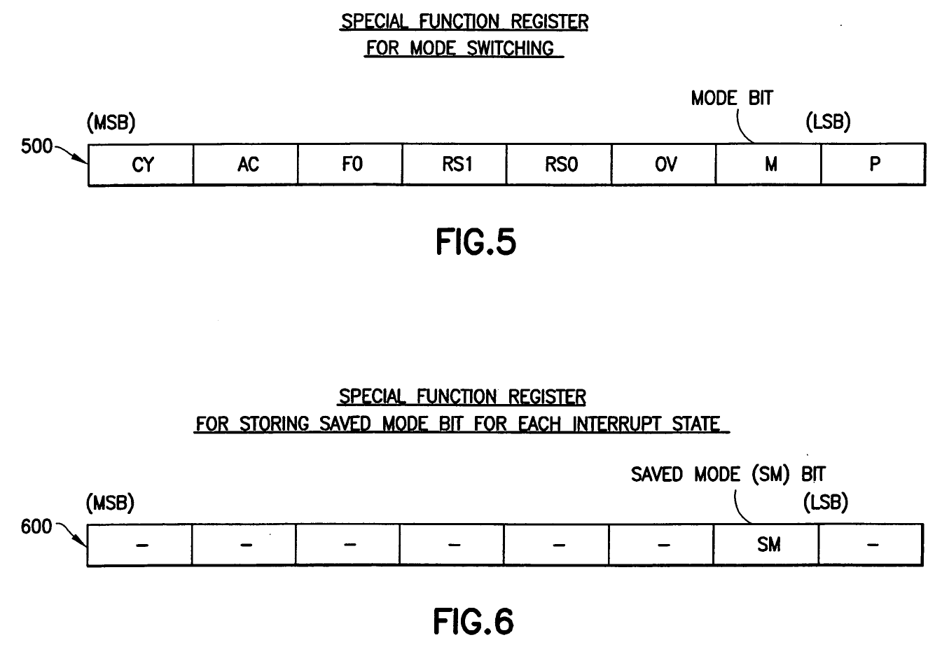

According to one aspect of the present invention, the semiconductor circuit 100 supports at least two modes of operation. In a secure kernel mode, all resources and services on the semiconductor circuit 100, such as special function registers, are accessible. In an application mode, certain special function registers are not accessible (and thus, the resources associated with such special function registers are also not accessible). In one exemplary implementation shown in FIG. 5, the mode of the semiconductor circuit is controlled by a mode bit, M, in the program status word (PSW) register of the processor core 300. For example, when the mode bit is 0, the semiconductor circuit 100 is in secure kernel mode and when the mode bit is 1, the semiconductor circuit 100 is in the user application mode.

In this manner, the mode bit controls whether certain hardware resources, such as special function registers, memories, communication channels and other peripheral devices, are accessible. Normally, the operating system is executed in a secure kernel mode, where most, if not all resources are accessible. Thus, when the semiconductor circuit 100 is operating in the kernel mode, all the system resources are accessible, including rights to read from and write to all the special function registers and memories.

Likewise, a user application is normally executed in a user mode, where certain hardware resources are not accessible. Thus, when the semiconductor circuit 100 is operating in a user mode, certain special function registers and memories, as defined by the access restriction settings, are not accessible. If a user application attempts to access a restricted resource in a user mode, a fault interrupt is generated. Generally, in the user mode, an application cannot (i) access and modify settings of the memory management unit 400; (ii) modify interrupt enable and interrupt priority special function registers; (iii) access memories not permitted by settings of the memory management unit 400; or (iv) change the mode bit, M, except through a software interrupt.

If a user application needs to access a restricted resource that is only available in the kernel mode, the user application invokes the kernel mode using an interrupt, in a manner discussed below. In this manner, the user application can access embedded resources through the interrupt-invoked kernel mode, that the user application otherwise couldn't access and the security of the semiconductor circuit 100 is ensured.

According to another aspect of the present invention, the memory map of the semiconductor circuit 100 is different in the two different modes. In this manner, the operating system/kernel is separated from user applications. Thus, the memory management unit 400 of the present invention extends a conventional memory management unit to support multiple modes of operation. As discussed further below in conjunction with FIG. 4, the memory management unit 400 is configurable and can be configured only when the semiconductor circuit 100 is in the kernel mode.

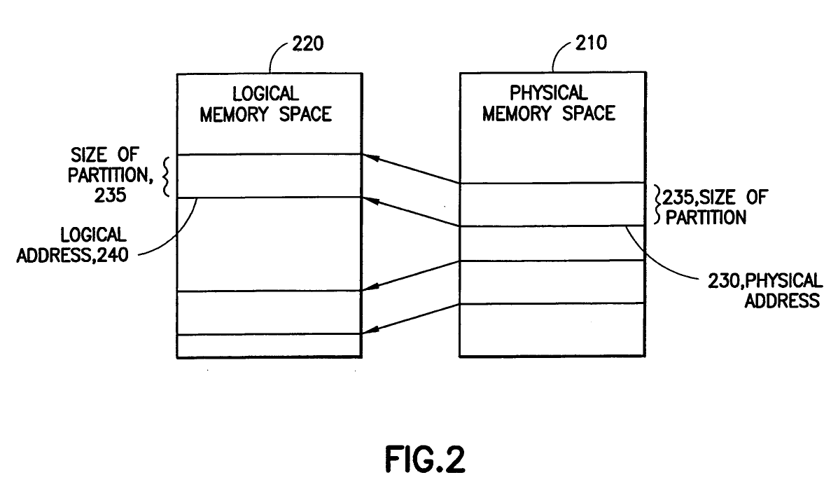

FIG. 2 illustrates the relationship between a physical address and logical address in the memory 130 of FIG. 1. Generally, as discussed further below in conjunction with FIG. 4, the memory management unit 400 partitions the memory 130 and restricts access of installed applications executing in the microprocessor core 300 to predetermined memory ranges. As shown in FIG. 2, a physical address 230 identifying a base memory address in the physical address space 210 of the memory 130 is translated to a logical address 240 identifying a base memory address in the logical address space 220 of the memory 130. The size of the partition is determined by a size of partition identifier 235.

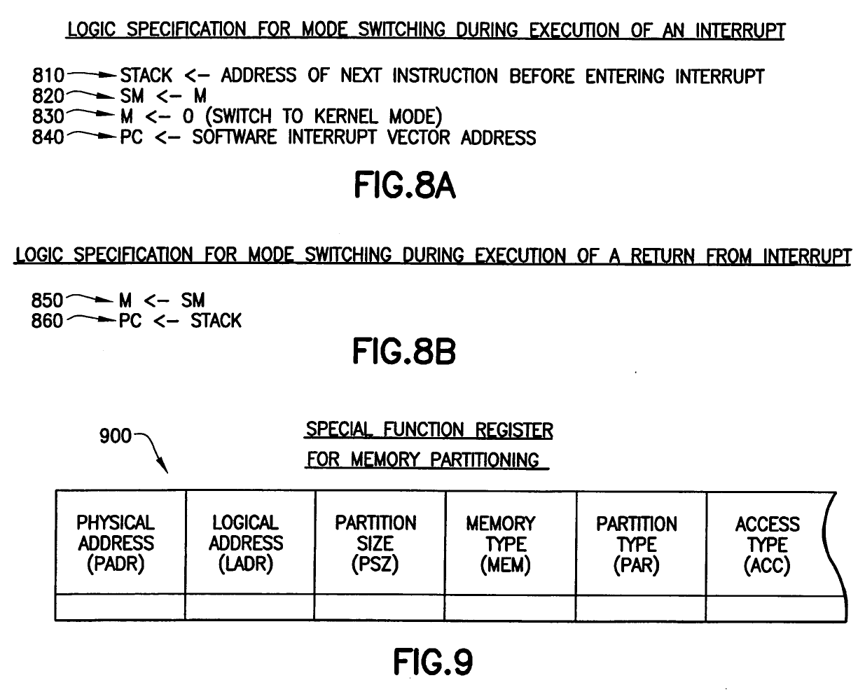

FIG. 3 is a schematic block diagram of the processor core 300 of FIG. 1. As shown in FIG. 3, the processor core 300 includes conventional CPU logic and functions 310, such as those supported by the Intel 80C51™ architecture. In addition, the present invention extends the conventional functions of a processor core to support multi-mode operation. Specifically, as discussed further below in conjunction with FIG. 8, the processor core 300 includes logic 800 for performing the mode switching of the present invention. In addition, as discussed further below in conjunction with FIGS. 5 and 6, the processor core 300 includes special function registers 500, 600 that perform mode switching.

FIG. 4 is a schematic block diagram of the memory management unit 400 of FIG. 1. As previously indicated, the memory management unit 400 provides an interface between the processor core 300 and the memory devices 130 for memory access operations. The memory management unit 400 imposes firewalls between the various applications executing on the semiconductor circuit 100 and permits hardware checked partitioning of the memory to limit access to only a predetermined memory range. The memory management unit 400 may be embodied as the memory management unit disclosed in U.S. Pat. No. 6,292,874, as modified herein to support the features and functions of the present invention, including multi-mode operation.

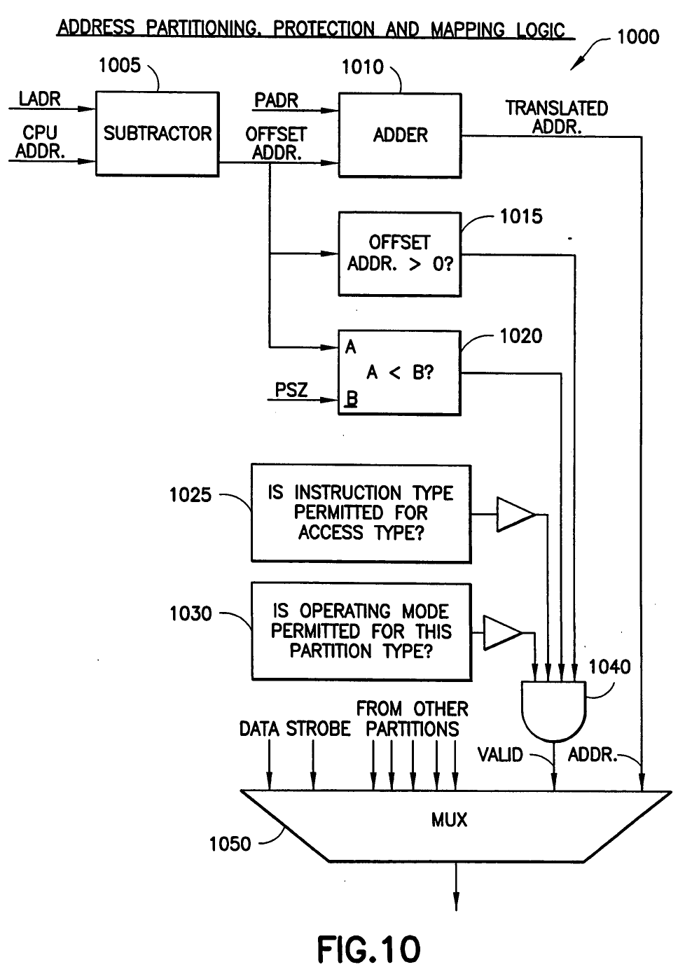

As shown in FIG. 4 and discussed further below in conjunction with FIG. 9, the memory management unit 400 includes special function registers 900 for performing memory partitioning. Generally, the special function registers 900 for performing memory partitioning record the physical and logical addresses, partition size and memory characteristics for each partition created by the memory management unit 400. In addition, as discussed further below in conjunction with FIG. 10, the memory management unit 400 includes address partitioning, protection and mapping logic 1000. Generally, the address partitioning, protection and mapping logic 1000 translates between physical and logical addresses, and confirms the validity of an operation performed on a given memory address (i.e., the address partitioning, protection and mapping logic 1000 ensures that an operation is valid for the partition).

FIG. 5 is an exemplary special function register 500 used by the processor core 300 of FIGS. 1 and 3 for storing a mode bit that controls the mode switching of the present invention. As previously indicated, the mode of the semiconductor circuit 100 can be controlled by a mode bit, M, in the program status word (PSW) register of the processor core 300. For example, when the mode bit is 0, the semiconductor circuit 100 is in secure kernel mode and when the mode bit is 1, the semiconductor circuit 100 is in the user application mode. The current value of the mode bit, M, should be available as an output of the processor core 300.

As shown in FIG. 5, the program status word register 500 includes the following conventional bits: carry flag (CY), auxiliary carry flag (AC) for BCD operations, general purpose, user definable flag (F0), register bank select (RS1 and RS0) that are set/cleared by software to determine working register bank, overflow flag (OV), and a parity flag (P); as well as the mode bit (M) in accordance with the present invention. It is noted that the exemplary mode bit, M, is a part of the program status word register, the mode bit is automatically saved and restored upon entering and exiting from interrupts.

FIG. 6 is an exemplary special function register used by the processor of FIGS. 1 and 3 for storing a saved mode bit, SM, for each interrupt state. As previously indicated, a user application that needs to access a restricted resource invokes the kernel mode using an interrupt. In this manner, the user application gains access to restricted resources through the interrupt-invoked kernel mode. In the exemplary Intel 80C51™ processor core 300, there are three interrupt states (normal program execution, low priority (software) interrupt and high priority (hardware) interrupt). The exemplary 80C51 processor core 300 provides an output, interrupt state, indicating the current interrupt state. The terms “low priority interrupt” and “software interrupt” are used interchangeably herein. Similarly, the terms “high priority interrupt” and “hardware interrupt” are used interchangeably herein. A software interrupt is invoked, for example, by setting an interrupt flag bit in a predetermined special function register. There is exemplary special function register 600 used by the processor core 300 for storing the saved mode bit, SM, for each interrupt state (low and high priority).

As discussed further below in conjunction with FIGS. 8A and 8B. upon entering an interrupt, the current mode bit, M, is automatically saved in the saved mode, SM, bit field of the special function register 600 corresponding to the interrupt state the processor is entering into (i.e., low or high priority), and the mode bit, M, will be cleared to ‘0’ always (for both low priority and high priority interrupts). As a result, the interrupts are always handled in kernel mode. In addition, upon exiting from an interrupt, the SM bit in the special function register 600 corresponding to the current interrupt state will be used to restore the value in the mode bit, M, of the program status word register. The saved mode bit, SM, is accessible only by interrupt handlers running in the kernel mode.

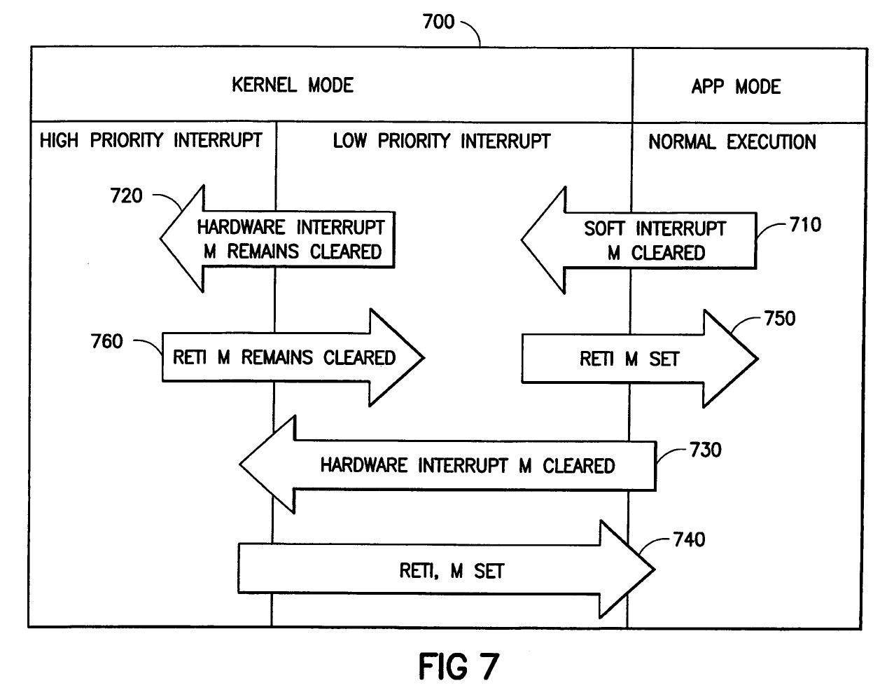

FIG. 7 is a flow chart 700 illustrating the mode switching in accordance with the present invention. The flow chart 700 illustrates how the mode bit, M, is automatically set and cleared upon entering into or exiting from interrupts, from normal operation in user mode. Normally, the semiconductor circuit 100 is executing an application in the user mode, and the mode bit, M, is set. When the device enters from a normal execution in user mode to a low priority software interrupt (step 710), the M bit is cleared. When the semiconductor circuit 100 enters from a low priority software interrupt to a high priority interrupt (step 720), the M bit remains cleared. When the semiconductor circuit 100 enters from a normal execution in user mode to a high priority interrupt (step 730), the M bit is cleared. When the semiconductor circuit 100 returns from a high priority interrupt to a normal user mode (step 740), the M bit is set. When the semiconductor circuit 100 returns from a low priority software interrupt to a normal user mode (step 750), the M bit is set. Finally, when the semiconductor circuit 100 returns from a high priority interrupt to a low priority software interrupt (step 760), the M bit remains cleared. An attempt to return from an interrupt (RETI) during a normal execution mode (and not from inside an interrupt handler) is not allowed, and should result in a fault interrupt.

The semiconductor circuit 100 is in a normal execution state and in kernel mode after a reset. Execution generally starts at address OOH and then from there, start up code can set up the semiconductor circuit 100, including interrupt enable and priorities, setting up the memory management unit 400 and loading the application(s). After the kernel finishes the initialization, the kernel should call a software interrupt. Within the software interrupt, the saved mode, SM, bit should be set, and a return from interrupt (RETI) should be executed to enter the application in a user mode. Before the return from interrupt (RETI) is executed, the kernel needs to put the destination address to the stack, make appropriate adjustments to the stack pointer and execute RETI, as discussed further below in conjunction with FIGS. 8A and 8B. Again, once the application is in a user mode, the application can invoke a software interrupt to request any kernel service. Any execution of RETI from the interrupt handler will take the processor core 300 back to the application in a user mode.

FIGS. 8A and 8B are logic specifications for performing mode switching during execution of an interrupt and a return from an interrupt, respectively. As previously indicated, mode switching is performed in accordance with the present invention through an invoked interrupt and then returning from the interrupt. A software interrupt is thus added to the architecture to allow voluntary mode switching. The software interrupt is invoked by writing to an interrupt bit. For example, a software interrupt is invoked by setting an interrupt flag bit in a predetermined special function register. As discussed hereinafter, when the interrupt is serviced, the program branches to an address pointed to by an interrupt vector and at the same time, the operating mode is switched to the secure kernel mode. The execution address of the next instruction in sequence before entering the interrupt is also saved to the stack, and the operating mode before the interrupt is saved in the saved mode, SM, bit of the special function register 600 that is appropriate for the current interrupt state (low and high priority). On returning from the software interrupt, the program execution will branch to where the execution was interrupted and continue from there. The operating mode will be restored to what was saved in the saved mode, SM, register.

FIG. 8A is a logic specification for performing mode switching during execution of an interrupt. As shown in FIG. 8A, the logic needs to perform a number of tasks 810, 820, 830, 840 in order to support a mode switch during an interrupt. Specifically, task 810 requires that the address of the next instruction before entering interrupt is stored in the stack. Task 820 requires that the current value of the mode bit, M, before the interrupt is stored in the appropriate saved mode, SM register of the special function register 600 for the interrupt state. Task 830 requires that the value of the mode bit, M, is set to zero to cause a switch to a kernel mode. Finally, the software interrupt vector address is recorded in the program counter as part of task 840. In this manner, the program will branch to the address pointed to by the interrupt vector.

FIG. 8B is a logic specification for performing mode switching during execution of a return from an interrupt (RETI). As shown in FIG. 8B, the logic needs to perform a number of tasks 850, 860 in order to support a mode switch during a return from an interrupt (RETI) Specifically, upon returning from an interrupt task 850 requires that the value of the saved mode, SM, bit is restored to the mode bit, M, and task 860 requires that the value that was stored in the stack (which is the address of the next instruction before entering the interrupt) is stored in the program counter.

In this manner, when the software interrupt returns, the execution will normally continue at the location where the interrupt is called. In addition, the operating mode will be restored to what the operating mode was before the software interrupt was serviced. Sometimes, the kernel software may need to re-adjust the branch destination address and the operating mode after the software interrupt returns (the software interrupt handler is part of the kernel). Within the software interrupt, the kernel can change the saved mode, SM, bit, and thus decide the mode of operation after the interrupt returns. It is noted that the saved mode, SM, can only be accessed while the device is in kernel mode. Before the return from interrupt (RETI) is executed, the kernel needs to put the destination address in the stack and make appropriate adjustments to the stack pointer. When the RETI is executed, the program will branch to the desired destination, and at the same time, the operating mode will be set to the desired value.

FIG. 9 is an exemplary special function register 900 used by the memory management unit 400 of FIGS. 1 and 4 for storing memory partitioning information. In order to partition and map the region of memory 130, the special function register 900 must record, for a given partition, the physical address (PADR); logical address (LADR) and partition size (PSZ). The physical address defines the start (base) address of the memory partition in the physical space. The logical address maps the physical memory to the logical memory space of the processor core 300. The partition size determines the size of the memory partition.

In addition to the above parameters for a memory partition, the special function register 900 also records, for a given memory partition, a memory type (MEM), partition type (PAR) and access type (ACC). The memory type (MEM) defines the type of physical memory that should be used to form the partition, such as one time programmable (OTP) memory, electrically erasable programmable read only memory (EEPROM) and random access memory (RAM).

Depending on the CPU mode, the memory management unit 400 behaves differently. The following partition types (PAR) are each is active in a specific mode:

| Partition Type | Characteristics |
|---|---|
| Kernel | partition in effect in kernel mode |
| Application | partition in effect in user mode |

Finally, the following exemplary access types (ACC) apply to both kernel and user modes:

| Access Type | Memory Characteristics |
|---|---|
| Read/Write | Memory can be read, executed from if |
| | configured as code or unified, and written |
| | to (i.e., no restrictions) |
| Read Only | Memory can be read, executed from if |
| | configured as code or unified, but not |
| | written to |
| Execute Only | Memory, if configured as code type or |
| | unified type, can be executed from. No |
| | other access (read, write) is permitted. If |
| | the memory is configured as data, no |
| | access is allowed. |

FIG. 10 is a schematic block diagram of exemplary address partitioning, protection and mapping logic 1000 used by the memory management unit of FIG. 4. As shown in FIG. 10, the address partitioning, protection and mapping logic 1000 includes a subtractor 1005 that subtracts the logical address of a partition from the address generated by the processor core 300 to generate an offset address. The offset address is then added by an adder 1010 to the corresponding physical address from the special function register 900 to generate the translated address.

In addition, in order to confirm the validity of the requested operation, the offset address is evaluated at stage 1015 to ensure that it is a positive number, and is evaluated at stage 1020 to ensure that it is less than the entire size of the partition, PSZ. In this manner, the memory management unit 400 ensures that a given application is limited to its own predetermined memory range. In addition, a test is performed at stage 1025 to ensure that the current instruction type is permitted based on the access type (ACC) specified for the partition. A further test is performed at stage 1030 to ensure that the current operating mode (kernel or user mode) is permitted for the current partition type (PAR). The outputs of each stage 1015, 1020, 1025, 1030 are evaluated by an AND gate 1040 to ensure that none of the specified restrictions are violated. If any restriction is violated the requested operation is prevented.

A multiplexer 1050 receives the address and valid flag generated by the address partitioning, protection and mapping logic 1000 for each partition. In addition, the multiplexer 1050 receives the data and strobe values generated by the processor core 300 and passes them through to its output, provided there is no restriction violation. If more than one partition is active at a time, the multiplexer 1050 will select the partition having the highest priority, according to a predefined policy.

In this manner, if an application attempts to access the memory 130 in a way that violates the settings of the memory management unit 400, a fault interrupt condition will be set by the address partitioning, protection and mapping logic 1000 and the semiconductor circuit 100 will enter into a high priority hardware interrupt. The exemplary types of violations include:

| Violation Type | Characteristics |
|---|---|
| Out of Bound Violation for | address for memory access is outside of |
| Code Fetch and MOVC | any defined partition |
| Out of Bound Violation for | Address for memory access is outside of |
| Data Access | any defined partition |
| Access Violation for Data | the type of access is not allowed by |
| | MMU. For example, attempt to write to |
| | memory that is read only. |
| Access Violation for Code | type of access is not allowed by MMU. |
| | For example, attempt to read from |
| | memory that is execution only. |

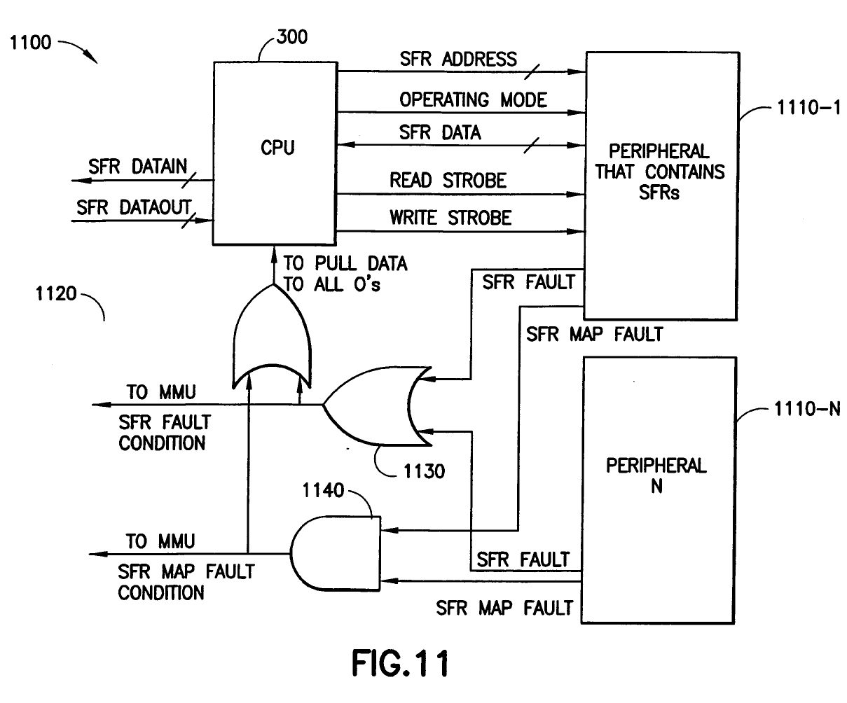

FIG. 11 is a schematic block diagram of a mechanism 1100 for restricting access to peripheral devices in accordance with one embodiment of the present invention. Access to peripherals, such as peripherals 1110-1 through 1110-N, are accomplished using special function registers in the exemplary Intel 80C51 architecture. In accordance with the present invention, access to such peripherals 1110 is thus restricted in a multi-mode implementation by restricting access to the special function register that controls the corresponding peripheral 1110. Such peripherals 1110 include analog peripherals and communication channels.

In one implementation, logic is included in the peripheral 1110 that will accept or refuse an access request based on the operating mode. As shown in FIG. 11, peripheral access control mechanism 1100 will evaluate the Operating Mode of the processor core 300 and if an illegal access is attempted during a user mode, the peripheral 1110 will generate a special function register fault that is applied to an OR gate 1130 that monitors the special function register fault flag generated by each peripheral 1110. If any peripheral 1110 generates the special function register fault then an SFR fault condition is generated that is sent to the memory management unit 400 to trigger a violation and prevent further memory accesses until the fault is addressed.

In addition, each peripheral 1110 can generate a special function register map fault flag if a request is sent to the peripheral, but there is no special function register at the specified address. The special function register map fault is applied to an AND gate 1140 that monitors the special function register map fault flags generated by each peripheral 1110. If all peripherals 1110 generate the special function register map fault then an SFR MAP fault condition is generated that is sent to the memory management unit 400 to trigger a violation and prevent further memory accesses until the fault is addressed. As shown in FIG. 11, the outputs of the OR gate 1130 and AND gate 1140 are monitored by an OR gate 1120 to determine if either an SFR fault or an SFR map fault condition is detected. Once either condition is detected, the OR gate 1120 will cause all the data to be pulled to all zeroes.

It is to be understood that the embodiments and variations shown and described herein are merely illustrative of the principles of this invention and that various modifications may be implemented by those skilled in the art without departing from the scope and spirit of the invention.

We claim:

1. A semiconductor circuit, comprising:
a memory; and
a processor for executing one or more applications, said processor supporting at least two operating modes.

2. The semiconductor circuit of claim 1, wherein said at least two operating modes includes a kernel mode.

3. The semiconductor circuit of claim 1, wherein said at least two operating modes includes an application mode.

4. The semiconductor circuit of claim 1, wherein an availability of one or more resources of said semiconductor circuit depends on said operating mode.

5. The semiconductor circuit of claim 1, further comprising a memory management unit that creates at least two partitions in said memory, each of said at least two partitions having a defined one of said at least two operating modes of said processor.

6. The semiconductor circuit of claim 1, wherein said processor sets a mode bit indicating a current operating mode.

7. The semiconductor circuit of claim 1, wherein an operating mode of said processor is changed by invoking an interrupt.

8. The semiconductor circuit of claim 1, wherein a current operating mode of said processor is recorded before processing an interrupt.

9. The semiconductor circuit of claim 8, wherein an interrupt causes a program to branch to an address pointed to by an interrupt vector.

10. The semiconductor circuit of claim 8, wherein an interrupt causes a next instruction in sequence before entering said interrupt to be recorded.

11. The semiconductor circuit of claim 8, wherein an interrupt causes an indication of said operating mode before entering said interrupt to be recorded.

12. The semiconductor circuit of claim 8, wherein a return from said interrupt causes program execution to branch to where the execution was interrupted prior to said interrupt.

13. The semiconductor circuit of claim 8, wherein a return from said interrupt causes said operating mode before entering said interrupt to be restored.

14. The semiconductor circuit of claim 1, further comprising a circuit for determining whether an instruction is permitted for a given partition.

15. The semiconductor circuit of claim 1, further comprising a circuit for determining whether an operating mode is permitted for a given partition.

16. A method for executing one or more applications in a semiconductor circuit, comprising:
providing access to one or more resources of said semiconductor circuit in an application kernel mode; and
providing access to one or more additional resources of said semiconductor circuit only in an application mode.

17. The method of claim 16, further comprising the step of creating at least two partitions in a memory on said semiconductor circuit, each of said at least two partitions having a defined one of said at least two operating modes of said processor.

18. The method of claim 16, further comprising the step of setting a mode bit indicating a current operating mode.

19. The method of claim 16, wherein said mode is changed by invoking an interrupt.

20. The method of claim 16, wherein a current mode is recorded before processing an interrupt.

21. The method of claim 20, wherein an interrupt causes a program to branch to an address pointed to by an interrupt vector.

22. The method of claim 20, wherein an interrupt causes a next instruction in sequence before entering said interrupt to be recorded.

23. The method of claim 20, wherein an interrupt causes an indication of said operating mode before entering said interrupt to be recorded.

24. The method of claim 20, wherein a return from said interrupt causes program execution to branch to where the execution was interrupted prior to said interrupt.

25. The method of claim 20, wherein a return from said interrupt causes said operating mode before entering said interrupt to be restored.

26. The method of claim 16, further comprising the step of determining whether an instruction is permitted for a given partition.

27. The method of claim 16, further comprising the step of determining whether an operating mode is permitted for a given partition.
